(19) United States
(12) Patent Application Publication
(10) Pub. No.: US 2024/0208480 A1
(43) Pub. Date: Jun. 27, 2024

(54) BRAKING CONTROL DEVICE

(71) Applicant: ADVICS CO., LTD., Kariya-shi, Aichi-ken (JP)

(72) Inventors: Takahiro MASAKI, Kariya-shi, Aichi-ken (JP); Ryota MAENO, Kariya-shi, Aichi-ken (JP)

(73) Assignee: ADVICS CO., LTD., Kariya-shi, Aichi-ken (JP)

(21) Appl. No.: 18/575,449

(22) PCT Filed: Jul. 29, 2022
(86) PCT No.: PCT/JP2022/029371

§ 371 Date: Dec. 29, 2023

(30) Foreign Application Priority Data
Jul. 30, 2021 (JP) 2021-125677

(51) Int. Cl. B60T 17/22; B60T 8/171

(52) U.S. Cl. CPC B60T 17/22; B60T 8/171

(57) ABSTRACT

During a normal condition of a braking control device, a first instruction unit gives instructions of braking force to be applied to a first wheel and a third wheel, and a second instruction unit gives instructions of braking force to be applied to a second wheel and a fourth wheel. When a failure occurs in the first instruction unit and the first instruction unit can no longer give the instructions of the braking force to be applied to the first wheel and the third wheel, the second instruction unit takes over the task of giving the instruction of braking force to be applied to the first wheel, and a third instruction unit takes over the task of giving the instruction of braking force to be applied to the third wheel.

### TECHNICAL FIELD

The present disclosure relates to a braking control device that controls braking force applied to a wheel of a vehicle.

### BACKGROUND ART

As a braking control device that controls braking force applied to each wheel of a vehicle, the device described in Patent Literature 1 is known. The braking control device disclosed in Patent Literature 1 includes, as electronic control units (ECUs) for giving the instruction of braking force to be applied to each wheel, a first ECU and a second ECU. In the braking control device disclosed in Patent Literature 1, when one of the ECUs fails, the braking force control of the wheels is continued by causing the other ECU to take over the processing having been performed by the failed ECU.

### CITATIONS LIST

### Patent Literature

Patent Literature 1: Japanese Patent Application Laid-Open No. 2019-89505

### SUMMARY

### Technical Problems

In the conventional braking control device, when one of the ECUs fails, the processing load of the other ECU increases drastically. Therefore, both of the ECUs need to have processing powers much higher than those required in ordinary processing.

### Solutions to Problems

A braking control device for addressing the issue problem described above is a device that controls braking force applied to a first wheel, a second wheel, a third wheel, and a fourth wheel that are wheels of a vehicle. The braking control device includes a first main instruction unit, a second main instruction unit, and a backup instruction unit, as instruction units for applying braking force that is to be applied to the wheels. In the braking control device, when both of the first main instruction unit and the second main instruction unit are functioning properly, the first main instruction unit gives an instruction of braking force to be applied to the first wheel and the third wheel, and the second main instruction unit gives an instruction of braking force to be applied to the second wheel and the fourth wheel. In the braking control device, at the time of a failure in which only the second main instruction unit, out of the first main instruction unit and the second main instruction unit, is functioning properly, the second main instruction unit takes over the task of giving the instruction of braking force to be applied to the first wheel, and a backup instruction unit takes over the task of giving an instruction of braking force to be applied to the third wheel.

Let us herein assumed an example in which the first main instruction unit of the braking control device stops functioning properly, and the function of the first main instruction unit is taken over only by the second main instruction unit. In such a case, when the first main instruction unit fails, the number of wheels for which the second main instruction unit gives instructions of braking force increases from two to four, and the processing load of the second main instruction unit increases accordingly. Let us now assume another example in which only a backup instruction unit is used to take over the function of the first main instruction unit when the first main instruction unit stops functioning properly. In such a case, the backup instruction unit is required to have functions that are equivalent to those of the first main instruction unit. It is, however, difficult, in terms of cost effectiveness, to provide a high-performance backup instruction unit, just in case of a failure of the first main instruction unit.

In this regard, in the braking control device, when the first main instruction unit stops functioning properly, the second main instruction unit and the backup instruction unit take over and share the tasks of giving instructions of the braking force to the first wheel and the third wheel, which have been performed by the first main instruction unit. Therefore, it is possible to suppress an increase in the processing load of the second main instruction unit at the time of a failure. It is also possible to keep the number of functions required in the backup instruction unit small. Therefore, a highly failure-resistant braking control device can be achieved.

### BRIEF DESCRIPTION OF DRAWINGS

FIG. 1 is a diagram schematically illustrating a configuration of a braking control device according to one embodiment.

FIG. 2 is a diagram illustrating how the braking control device operates in a normal condition.

FIG. 3 is a diagram illustrating how the braking control device operates during a failure of the first instruction unit.

FIG. 4 is a diagram illustrating how the braking control device operates during failures of the first instruction unit and the second instruction unit.

FIG. 5 is a diagram illustrating how the braking control device according to a modification operates during a three-system failure.

FIG. 6 is a diagram illustrating how a braking control device according to another modification operates during a failure of the first instruction unit.

FIG. 7 is a diagram illustrating how a braking control device according to still another modification operates during a failure of the first instruction unit.

### DESCRIPTION OF EMBODIMENT

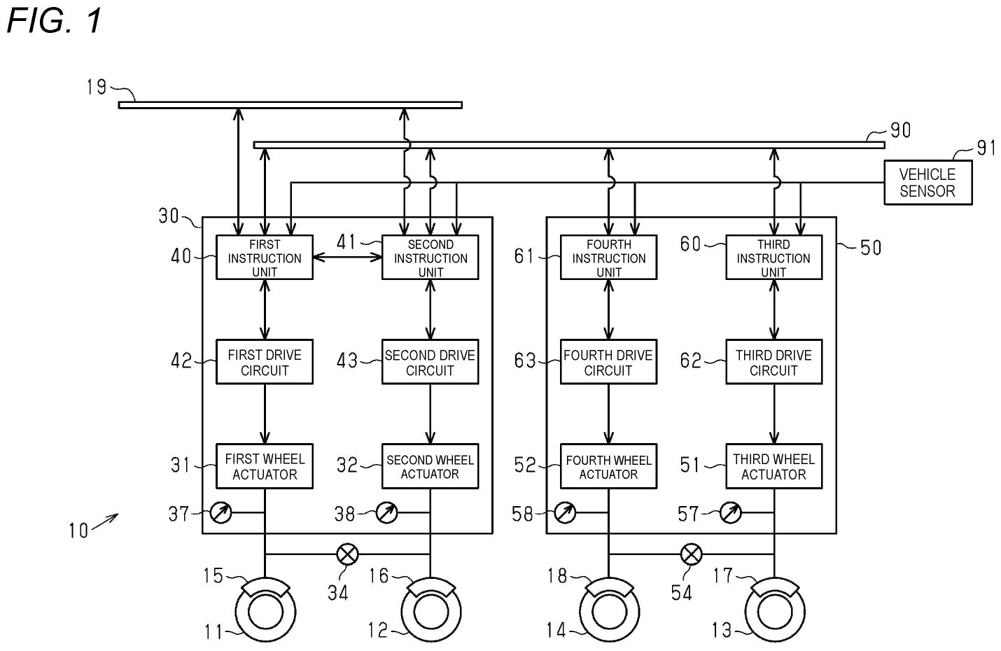

One embodiment for embodying the braking control device will now be explained with reference to FIGS. 1 to 4.

### (Configuration of Braking Control Device 10)

A configuration of a braking control device 10 according to the embodiment will now be explained with reference to FIG. 1. The braking control device 10 according to this embodiment controls the braking force applied to the four wheels including a first wheel 11, a second wheel 12, a third wheel 13, and a fourth wheel 14 of the vehicle. In this embodiment, the first wheel 11 is the front left wheel of the vehicle; the second wheel 12 is the front right wheel; the third wheel 13 is the rear left wheel; and the fourth wheel 14 is the rear right wheel. The braking force to be applied to each of these wheels is controlled by adjusting the hydraulic pressure of corresponding one of wheel cylinders 15 to 18 in the respective wheels.

The braking control device 10 includes a first braking unit 30 and a second braking unit 50. The first braking unit 30 includes a hydraulic circuit for the wheel cylinder 15 in the first wheel 11, and the wheel cylinder 16 in the second wheel 12. The second braking unit 50 includes a hydraulic circuit for the wheel cylinder 17 in the third wheel 13, and the wheel cylinder 18 in the fourth wheel 14.

### (Configuration of First Braking Unit 30)

The first braking unit 30 includes a first wheel actuator 31 for generating hydraulic pressure of the wheel cylinder 15 in the first wheel 11, and a second wheel actuator 32 for generating hydraulic pressure of the wheel cylinder 16 in the second wheel 12. In this embodiment, an electric cylinder, which generates hydraulic pressure by causing an electric motor to move a piston inside the cylinder, is used for each of the first wheel actuator 31 and the second wheel actuator 32.

The first braking unit 30 includes a first electromagnetic valve 34. The first electromagnetic valve 34 is a normally open electromagnetic valve, which remains closed when a current is being applied thereto, and opens when the current stops. The wheel cylinder 15 in the first wheel 11 and the wheel cylinder 16 in the second wheel 12 are connected to each other via the first electromagnetic valve 34. While the first electromagnetic valve 34 is open, the first wheel actuator 31 and the second wheel actuator 32 are both connected to each of the wheel cylinder 15 and the wheel cylinder 16, in the first wheel 11 and the second wheel 12, respectively.

The first braking unit 30 also includes hydraulic pressure sensors 37, 38, a first drive circuit 42, and a second drive circuit 43. The hydraulic pressure sensor 37 is a sensor that detects the hydraulic pressure generated by the first wheel actuator 31. The hydraulic pressure sensor 38 is a sensor that detects the hydraulic pressure generated by the second wheel actuator 32. The first drive circuit 42 is a circuit for controlling the power of first wheel actuator 31, and the second drive circuit 43 is a circuit for controlling the power of second wheel actuator 32.

The first braking unit 30 includes a first instruction unit 40 and a second instruction unit 41. The first instruction unit 40 is an electronic control unit including one or more processors for executing various processes for controlling the braking force of the vehicle, and a memory storing therein a control program and data. The second instruction unit 41 is an electronic control unit having the same configuration as that of the first instruction unit 40. The first instruction unit 40 is connected controllably to the first drive circuit 42, and the second instruction unit 41 is connected controllably to the second drive circuit 43. Both of the first instruction unit 40 and the second instruction unit 41 are connected controllably to the first electromagnetic valve 34.

The first instruction unit 40 and the second instruction unit 41 are connected to an in-vehicle network circuit 19. Via this in-vehicle network circuit 19, the first braking unit 30 communicates with devices other than the braking control device 10 onboard the vehicle. The first instruction unit 40 and the second instruction unit 41 are also connected to a braking control device internal communication 90. The first instruction unit 40 and the second instruction unit 41 are also connected to vehicle sensors 91, such as a stroke sensor and a wheel speed sensor, in a manner enabled to receive sensor signals therefrom. Note that the first instruction unit 40 and the second instruction unit 41 are communicably connected to each other inside the first braking unit 30.

### (Configuration of Second Braking Unit 50)

The hydraulic circuit for the second braking unit 50 has the same configuration as that of the hydraulic circuit for the first braking unit 30. In other words, the second braking unit 50 includes a third wheel actuator 51 for generating hydraulic pressure of the wheel cylinder 17 in the third wheel 13, and a fourth wheel actuator 52 for generating hydraulic pressure of the wheel cylinder 18 in the fourth wheel 14. The second braking unit 50 also includes a second electromagnetic valve 54 that is a normally open electromagnetic valve. The wheel cylinder 17 in the third wheel 13 and the wheel cylinder 18 in the fourth wheel 14 are connected to each other via a second electromagnetic valve 54.

The second braking unit 50 also includes hydraulic pressure sensors 57, 58, a third drive circuit 62, and a fourth drive circuit 63. The hydraulic pressure sensor 57 is a sensor that detects the hydraulic pressure generated by the third wheel actuator 51. The hydraulic pressure sensor 58 is a sensor that detects the hydraulic pressure generated by the fourth wheel actuator 52. The third drive circuit 62 is a circuit for controlling the power of third wheel actuator 51, and the fourth drive circuit 63 is a circuit for controlling the power of the fourth wheel actuator 52.

The second braking unit 50 includes another two electronic control units that are a third instruction unit 60 and a fourth instruction unit 61. The third instruction unit 60 is controllably connected to the third drive circuit 62, and the fourth instruction unit 61 is controllably connected to the fourth drive circuit 63. Both of the third instruction unit 60 and the fourth instruction unit 61 are connected controllably to the second electromagnetic valve 54.

The third instruction unit 60 and the fourth instruction unit 61 are also connected to the braking control device internal communication 90. Via the braking control device internal communication 90, the third instruction unit 60 and the fourth instruction unit 61 can communicate with the first instruction unit 40 and the second instruction unit 41. The third instruction unit 60 and the fourth instruction unit 61 are connected to the vehicle sensors 91, such as a stroke sensor and a wheel speed sensor, in a manner enabled to receive sensor signals therefrom.

### (Operation of Braking Control Device 10 in Normal Condition)

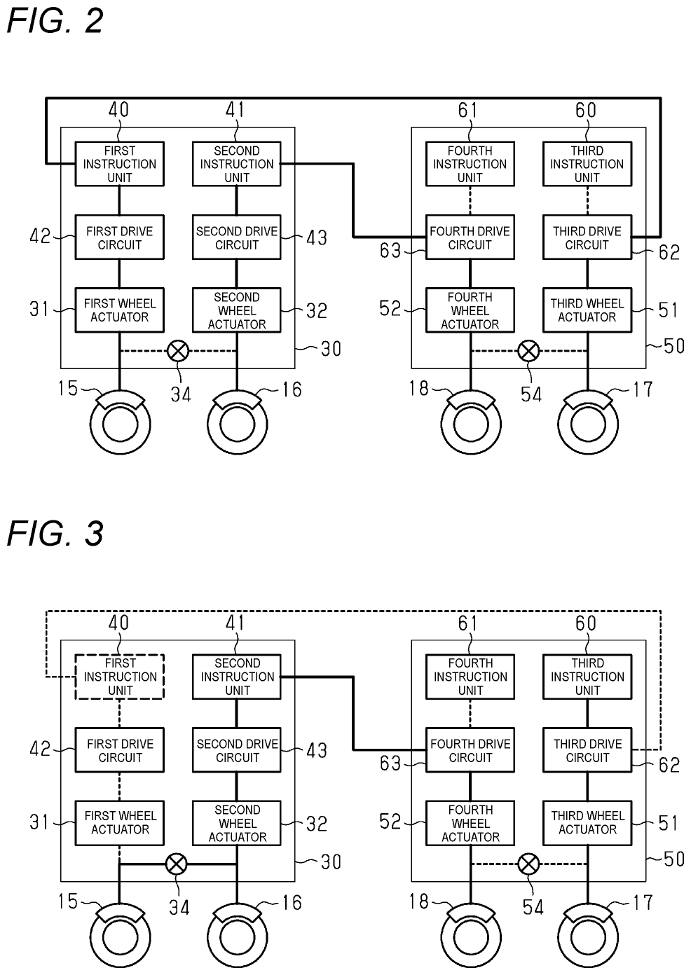

An operation of the braking control device 10 in a normal condition will now be explained with reference to FIG. 2. The normal condition herein is a condition in which both of the first instruction unit 40 and the second instruction unit 41 are functioning properly. In the explanation hereunder, the hydraulic pressure of the wheel cylinder 15 in the first wheel 11 is referred to as a first wheel hydraulic pressure P1, and the hydraulic pressure of the wheel cylinder 16 in the second wheel 12 is referred to as a second wheel hydraulic pressure P2. The hydraulic pressure of the wheel cylinder 17 in the third wheel 13 is referred to as a third wheel hydraulic pressure P3, and the hydraulic pressure of the wheel cylinder 18 in the fourth wheel 14 is referred to as a fourth wheel hydraulic pressure P4.

In FIGS. 2 to 7, among the components of the braking control device 10 illustrated, elements functioning properly are indicated in a solid line, and elements not functioning properly is indicated in a broken line. In FIGS. 2 to 7, among the transmission paths of information and of the hydraulic pressures among the components of the braking control device 10 and the wheel cylinders 15 to 18 illustrated, those that are functioning are indicated in a solid line, and those that are not functioning are represented in a broken line.

The first instruction unit 40 and the second instruction unit 41 in the normal condition instruct to apply current to the first electromagnetic valve 34. The first electromagnetic valve 34 in the normal condition is therefore closed. In this manner, the first wheel hydraulic pressure P1 is generated by the first wheel actuator 31 in the normal condition. The second wheel hydraulic pressure P2 is generated by the second wheel actuator 32 in the normal condition.

The third instruction unit 60 and the fourth instruction unit 61 in the normal condition instruct to apply current to the second electromagnetic valve 54. The second electromagnetic valve 54 in the normal condition is therefore closed. In this manner, the third wheel hydraulic pressure P3 is generated by the third wheel actuator 51 in the normal condition. The fourth wheel hydraulic pressure P4 is generated by the fourth wheel actuator 52 in the normal condition.

The first instruction unit 40 in the normal condition calculates a target first wheel hydraulic pressure P1* that is a target value for the first wheel hydraulic pressure P1, and a target third wheel hydraulic pressure P3* that is a target value for the third wheel hydraulic pressure P3, based on the pedal stroke or the like. The first instruction unit 40 then transmits the calculated value of the target first wheel hydraulic pressure P1* to the first drive circuit 42. The first drive circuit 42 adjusts the power for driving the first wheel actuator 31 so as to match the detected value of the hydraulic pressure having been generated by the first wheel actuator 31, the detected value being detected by the hydraulic pressure sensor 37, to the calculated value of the target first wheel hydraulic pressure P1* received from the first instruction unit 40. The first instruction unit 40 also transmits the calculated value of the target third wheel hydraulic pressure P3* to the third drive circuit 62. The third drive circuit 62 adjusts the power for driving the third wheel actuator 51 so as to match the detected value of the hydraulic pressure having been generated by the third wheel actuator 51, the detected value being detected by the hydraulic pressure sensor 37, to the received calculated value of the target third wheel hydraulic pressure P3*. In this embodiment, the first instruction unit 40 transmits the calculated value of the target third wheel hydraulic pressure P3* to the third drive circuit 62 via the in-vehicle network circuit 19 and the third instruction unit 60.

The second instruction unit 41 in the normal condition calculates a target second wheel hydraulic pressure P2* that is a target value for the second wheel hydraulic pressure P2, and a target fourth wheel hydraulic pressure P4* that is a target value for the fourth wheel hydraulic pressure P4, based on the pedal stroke or the like. The second instruction unit 41 then transmits the calculated value of the target second wheel hydraulic pressure P2* to the second drive circuit 43. The second drive circuit 43 adjusts the power for driving the second wheel actuator 32 so as to match the detected value of the hydraulic pressure having been generated by the second wheel actuator 32, the detected value being detected by the hydraulic pressure sensor 38, to the received calculated value of the target second wheel hydraulic pressure P2*. The second instruction unit 41 transmits the calculated value of the target fourth wheel hydraulic pressure P4* to the fourth drive circuit 63. The fourth drive circuit 63 adjusts the power for driving the fourth wheel actuator 52 so as to match the detected value of the hydraulic pressure having been generated by the fourth wheel actuator 52, the detected value being detected by the hydraulic pressure sensor 37, to the received calculated value of the target fourth wheel hydraulic pressure P4*. In this embodiment, the second instruction unit 41 transmits the calculated value of the target fourth wheel hydraulic pressure P4* to the fourth drive circuit 63 via the in-vehicle network circuit 19 and the fourth instruction unit 61.

The first instruction unit 40 in the normal condition gives an instruction of braking force to be applied to the first wheel 11 by calculating and transmitting the calculated value of the target first wheel hydraulic pressure P1*. The second instruction unit 41 in the normal condition gives an instruction of braking force to be applied to the second wheel 12 by calculating and transmitting the calculated value of the target second wheel hydraulic pressure P2*.

At the same time, in the normal condition, the first instruction unit 40 calculates the target third wheel hydraulic pressure P3*, and the first instruction unit 40 transmits the target third wheel hydraulic pressure P3* to the third drive circuit 62 via inter-brake communication 70. In the same manner, the second instruction unit 41 gives an instruction of braking force to be applied to the fourth wheel 14, in the normal condition.

### (Diagnoses of Failure in First Instruction Unit 40 and Second Instruction Unit 41)

The braking control device 10 makes a failure diagnosis for diagnosing whether the first instruction unit 40 and the second instruction unit 41 are functioning properly or not. An embodiment of such a failure diagnosis will now be explained.

In this embodiment, the condition in which the first instruction unit 40 is not functioning properly also include a condition in which the first wheel actuator 31 or the first drive circuit 42 is experiencing a failure. In other words, in this embodiment, the condition in which the first instruction unit 40 is not functioning properly is defined as a condition in which some function related to the application of the braking force to the first wheel 11 fails to operate according to an instruction from the first instruction unit 40 that is in the normal condition. In this embodiment, the condition in which the second instruction unit 41 is not functioning properly also includes a condition in which the second wheel actuator 32 or the second drive circuit 43 is experiencing a failure. In other words, in this embodiment, the condition in which the second instruction unit 41 is not functioning properly is defined as a condition in which some function related to the application of the braking force to the second wheel 12 fails to operate according to an instruction from the second instruction unit 41 that is in the normal condition.

The first instruction unit 40 and the second instruction unit 41 make self-diagnoses of whether the first instruction unit 40 and the second instruction unit 41 are functioning properly, respectively. If the first instruction unit 40 finds out that some failure has occurred in the first instruction unit 40, within the capability by which the self-diagnosis function can be maintained, the first instruction unit 40 notifies the second instruction unit 41, the third instruction unit 60, and the fourth instruction unit 61 of the occurrence of the failure. If the second instruction unit 41 finds out that some failure has occurred in the second instruction unit 41, within the capability by which the self-diagnosis function can be maintained, the second instruction unit 41 notifies the first instruction unit 40, the third instruction unit 60, and the fourth instruction unit 61 of the occurrence of the failure.

Each one of the first instruction unit 40 and the second instruction unit 41 also monitors as to whether the other one of is functioning properly. With this, even when a failure including the loss of the self-diagnosis function occurs in any one of the first instruction unit 40 and the second instruction unit 41, it is possible to find out that of the failure has occurred. If the first instruction unit 40 finds out that the second instruction unit 41 is not functioning properly, the first instruction unit 40 notifies the third instruction unit 60 and the fourth instruction unit 61 of the occurrence of the failure in the second instruction unit 41. In the same manner, if the second instruction unit 41 finds out that first instruction unit 40 is not functioning properly, the second instruction unit 41 notifies the third instruction unit 60 and the fourth instruction unit 61 of the occurrence of the failure in the first instruction unit 40.

The third instruction unit 60 also determines that the first instruction unit 40 is not functioning properly when the calculated value of the target third wheel hydraulic pressure P3* ceases to be received from the first instruction unit 40. In the same manner, the fourth instruction unit 61 determines that the second instruction unit 41 is not functioning properly when the calculated value of the target fourth wheel hydraulic pressure P4* ceases to be received from the second instruction unit 41.

### (Operation of Braking Control Device 10 at Time of Single-System Failure)

An operation of the braking control device 10 at the time of a single-system failure will now be explained with reference to FIG. 3. The single-system failure herein is a condition in which only one of the first instruction unit 40 and the second instruction unit 41 is functioning properly. FIG. 3 illustrates how the braking control device 10 operates when only the second instruction unit 41, out of the first instruction unit 40 and the second instruction unit 41, is functioning properly.

To begin with, an example in which a failure has occurred in the first instruction unit 40 will be explained. Upon finding out that the failure has occurred in the first instruction unit 40, the second instruction unit 41 stops applying current to the first electromagnetic valve 34. This causes the first electromagnetic valve 34 to open. The wheel cylinder 15 in the first wheel 11 then becomes communicably connected to the wheel cylinder 16 in the second wheel 12, and the second wheel actuator 32 becomes able to generate both of the first wheel hydraulic pressure P1 and the second wheel hydraulic pressure P2.

At this time, the second instruction unit 41 calculates the target second wheel hydraulic pressure P2* and the target fourth wheel hydraulic pressure P4*, in the same manner as in the normal condition. The second instruction unit 41 then transmits the calculated value of the target second wheel hydraulic pressure P2* to the second drive circuit 43, and transmits the calculated value of the target fourth wheel hydraulic pressure P4* to the fourth drive circuit 63. The second drive circuit 43 adjusts the power for driving the second wheel actuator 32 based on the calculated value of the target second wheel hydraulic pressure P2* received from the second instruction unit 41. At this time, the wheel cylinder 15 in the first wheel 11 and the wheel cylinder 16 in the second wheel 12 are communicably connected each other, as mentioned earlier. Therefore, it can be said that the second instruction unit 41 gives instructions of the braking force to be applied to the first wheel 11, to the second wheel 12, and the fourth wheel 14.

Meanwhile, the third instruction unit 60 has already found out that the failure has occurred in the first instruction unit 40, by being notified by the first instruction unit 40 or the second instruction unit 41, as described above. The third instruction unit 60 may also determine that a failure has occurred in the first instruction unit 40 based on a fact that the calculated value of the target third wheel hydraulic pressure P3* has ceased to be received. When the third instruction unit 60 determines that a failure has occurred in the first instruction unit 40, by means of any of these, the third instruction unit 60 starts failure avoidance control described below. In the failure avoidance control, the third instruction unit 60 calculates the target third wheel hydraulic pressure P3* based on the pedal stroke or the like, and transmits the target third wheel hydraulic pressure P3* to the third drive circuit 62. Therefore, in this control, the third instruction unit 60 gives an instruction of braking force to be applied to the third wheel 13.

By contrast, when only the first instruction unit 40, out of the first instruction unit 40 and the second instruction unit 41, is functioning properly, the braking control device 10 performs the following operation. In other words, in this situation, the first instruction unit 40 stops applying current to the first electromagnetic valve 34, and then calculates and transmits the target first wheel hydraulic pressure P1* and the target third wheel hydraulic pressure P3*. When the fourth instruction unit 61 determines that a failure has occurred in the second instruction unit 41, the fourth instruction unit 61 starts calculating the target fourth wheel hydraulic pressure P4*, and transmitting the calculated value to the fourth drive circuit 63. Therefore, in this case, the first instruction unit 40 gives an instruction of braking force to be applied to the first wheel 11, the second wheel 12, and the third wheel 13. In this case, the fourth instruction unit 61 gives the instruction of braking force to be applied to the fourth wheel 14.

### (Operation of Braking Control Device 10 at Time of Two-System Failure)

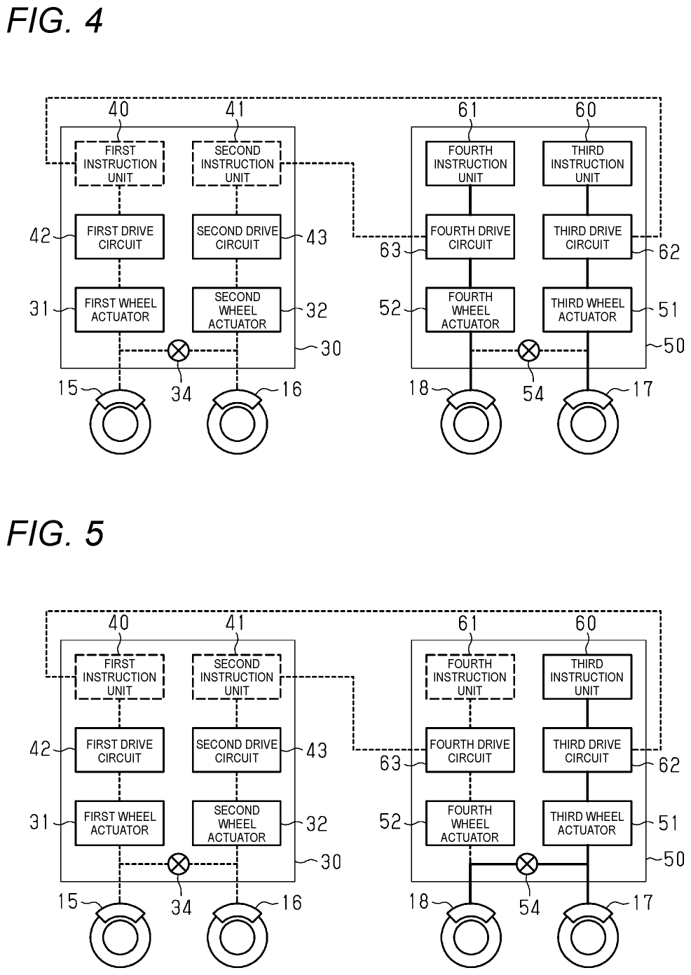

An operation of the braking control device 10 at the time of two-system failure will now be explained with reference to FIG. 4. The two-system failure herein refers to a condition in which both of the first instruction unit 40 and the second instruction unit 41 are not functioning properly.

As mentioned earlier, once the third instruction unit 60 determines that the failure has occurred in the first instruction unit 40, the third instruction unit 60 starts calculating the target third wheel hydraulic pressure P3*, and transmitting the calculated value to the third drive circuit 62. When the fourth instruction unit 61 determines that a failure has occurred in the second instruction unit 41, the fourth instruction unit 61 starts calculating the target fourth wheel hydraulic pressure P4*, and transmitting the calculated value to the fourth drive circuit 63. Therefore, in this case, the third instruction unit 60 gives the instruction of braking force to be applied to the third wheel 13. Furthermore, in this case, the fourth instruction unit 61 gives the instruction of braking force to be applied to the fourth wheel 14.

When the first instruction unit 40 and the second instruction unit 41 both fail, the current application to the first electromagnetic valve 34 stops. With no current being applied to the first electromagnetic valve 34, the first wheel actuator 31 and the second wheel actuator 32 can no longer generate the first wheel hydraulic pressure P1 nor the second wheel hydraulic pressure P2. By connecting a master cylinder to the wheel cylinders 15 and 16, the master cylinder can generate the first wheel hydraulic pressure P1 and the second wheel hydraulic pressure P2. In this configuration, a master cut valve that is a normally open electromagnetic valve is provided between each of the wheel cylinders 15 and 16, and the master cylinder. When at least one of the first wheel actuator 31 and the second wheel actuator 32 is caused to generate the first wheel hydraulic pressure P1 and the second wheel hydraulic pressure P2, it is preferable to cause the master cut valve to cut off the connection between the master cylinder and each of the wheel cylinders 15 and 16.

When all of the first instruction unit 40, the second instruction unit 41, the third instruction unit 60, and the fourth instruction unit 61 fail to function property, due to a cause such as power loss, the braking control device 10 operates in the following manner. In other words, in such a situation, the current application to both of the first electromagnetic valve 34 and the second electromagnetic valve 54 stops. In this case, by connecting the master cylinder to each wheel cylinders 15 to 18, in the same manner as described above, the master cylinder can generate the first wheel hydraulic pressure P1, the second wheel hydraulic pressure P2, the third wheel hydraulic pressure P3, and the fourth wheel hydraulic pressure P4. To cause the braking control device 10 to function in the manner described above, a master cut valve, which is a normally open electromagnetic valve, is provided between each of the wheel cylinders 15 to 18 and the master cylinder. When any of the four actuators is then caused to generate the first wheel hydraulic pressure P1, the second wheel hydraulic pressure P2, the third wheel hydraulic pressure P3, and the fourth wheel hydraulic pressure P4, it is preferable to cause the master cut valve to cut off the connections between the master cylinder and the wheel cylinders 15 to 18.

### (Operation and Effect Achieved by Embodiment)

Operations and effects achieved by this embodiment will now be explained.

In the braking control device 10 according to this embodiment, during the normal condition, the first instruction unit 40 gives instructions of the braking force to be applied to the first wheel 11 and the third wheel 13. During the normal condition, the second instruction unit 41 gives instructions of the braking force to be applied to the second wheel 12 and the fourth wheel 14. In other words, during the normal condition, one of the first instruction unit 40 and the second instruction unit 41 gives instructions of the braking force for one of the front wheels and for one of the rear wheels, and the other gives instructions of the braking force for the other one of the front wheels and the other one of the rear wheels.

The braking control device 10 according to this embodiment also includes another pair of instruction units, which are the third instruction unit 60 and the fourth instruction unit 61, in addition to the two instruction units giving instructions of the braking force during the normal condition. In the following description, the first instruction unit 40 and the second instruction unit 41 giving instructions of the braking force in the normal condition will be referred to as main instruction units, and the other third instruction unit 60 and fourth instruction unit 61 will be referred to as backup instruction units. In the following description, of the two main instruction units, the ECU experiencing a failure at the time of the one-system failure will be referred to as a failed main instruction unit, and the ECU functioning properly will be referred to as a functioning main instruction unit.

In the following description, a set of an instruction unit, a drive circuit that is the immediate receiver of the target hydraulic pressure transmitted from the instruction unit, an actuator that is driven by the drive circuit, and a wheel cylinder to which the actuator is constantly connected will be referred to as a system. The first braking unit 30 includes two systems: a system including the first instruction unit 40, the first drive circuit 42, and the first wheel actuator 31; and another system including the second instruction unit 41, the second drive circuit 43, and the second wheel actuator 32. The second braking unit 50 also includes two systems: a system including the third instruction unit 60, the third drive circuit 62, and the third wheel actuator 51; and another system including the fourth instruction unit 61, the fourth drive circuit 63, and the fourth wheel actuator 52.

At the time of a single-system failure in which only one of the two main instruction units is functioning properly, the functioning main instruction unit and a backup instruction unit take over the tasks of giving instructions of the braking force for the two wheels, the tasks having been performed by the failed main instruction unit, and share the load. In other words, at the time of a single-system failure in which the second instruction unit 41 has failed, the first instruction unit 40 takes over the task of giving the instruction of braking force to be applied to the second wheel 12, and the fourth instruction unit 61 takes over the task of giving the instruction of braking force to be applied to the fourth wheel 14. At the time of a single-system failure in which the first instruction unit 40 fails, the second instruction unit 41 takes over the task of giving the instruction of braking force applied to the first wheel 11, and the third instruction unit 60 takes over the task of giving the instruction of braking force applied to the third wheel 13.

Let us now consider an example in which only the functioning main instruction unit takes over the function of the failed main instruction unit, at the time of a single-system failure. In this configuration, when a single-system failure occurs, the functioning main instruction unit alone needs to perform the tasks of giving instructions of the braking force for the four wheels, the tasks having been shared between the two main instruction units during the normal condition. Therefore, such a configuration requires each of such main instruction units to have a higher processing power that is enough to give instructions of braking force for the four wheels.

Let us now assume a configuration in which only the backup instruction units takes over the function of the failed main instruction unit. The backup instruction unit in this case needs to have functions equivalent to those of the main instruction unit. It is, however, not desirable, from the viewpoint of cost effectiveness, to provide a high processing power to the backup instruction unit just in case of failures.

In this regard, in this embodiment, the functioning main instruction unit and the backup instruction unit take over and share the function of the failed main instruction unit. Therefore, the braking force control for all of the wheels can be continued even when a single-system failure occurs, without using any extremely high-performance main instruction unit and backup instruction unit. In the manner described above, the braking control device 10 according to this embodiment contributes to the improvement of failure resistance.

In the braking control device 10, when a one-system failure occurs, the first electromagnetic valve 34 is opened so that the wheel cylinder 15 in the first wheel 11 and the wheel cylinder 16 in the second wheel 12 are communicably connected to each other. As a result, the actuator belonging to the same system as the functioning main instruction unit can generate the hydraulic pressure for both of the wheel cylinder 15 in the first wheel 11 and the wheel cylinder 16 in the second wheel 12. Therefore, even if the number of wheels for which the functioning main instruction unit gives an instruction of braking force increases from two, during the normal condition, to three at the time of a one-system failure, the number of target hydraulic pressures to be calculated and the number of drive circuits to which the calculated values are transmitted remain two. In other words, the functions required for the functioning main instruction unit at the time of the single-system failure remain substantially the same as those required during the normal condition. The main instruction unit will give the instructions of the same braking force for the first wheel 11 and the second wheel 12.

In addition, the third instruction unit 60 in the braking control device 10 according to this embodiment determines that the first instruction unit 40 is not functioning properly based on a fact that the transmission of the target third wheel hydraulic pressure P3* to the third drive circuit 62 has stopped. The fourth instruction unit 61 determines that the second instruction unit 41 is not functioning properly based on a fact that the transmission of the target fourth wheel hydraulic pressure P4* to the fourth drive circuit 63 has stopped. In response to this determination, the third instruction unit 60 and the fourth instruction unit 61 start the failure avoidance control. Therefore, the backup instruction units can initiate the failure avoidance control even when the main instruction unit does not receive the notification of a failure from the main instruction due to a communication failure, or when the main instruction unit is not capable of transmitting the notification of the failure.

When control for vehicle skid suppression is to be performed, the braking control device 10 is required to perform more advanced braking force control for the first wheel 11 and the second wheel 12, which are the front wheels, than that required for the third wheel 13 and the fourth wheel 14, which are the rear wheels. In the braking control device 10 according to this embodiment, by contrast, the wheels for which the backup instruction units give instructions of the braking force are only the third wheel 13 and the fourth wheel 14, which are rear wheels. In this embodiment, the first instruction unit 40 and the second instruction unit 41, which are the main instruction units, are mounted on the first braking unit 30, and the third instruction unit 60 and the fourth instruction unit 61, which are the backup instruction units, are mounted on the second braking unit 50. Therefore, the functions required for more advanced braking force control for the front wheels are required only on the first braking unit 30, and the second braking unit 50 can have a simpler configuration than that of the first braking unit 30.

### (Corresponding Relationship)

In this embodiment, out of the first instruction unit 40 and the second instruction unit 41, the instruction unit that having failed in the single-system failure corresponds to a first main instruction unit, and the instruction unit that is functioning properly corresponds to a second main instruction unit. One of the third instruction unit 60 and the fourth instruction unit 61 corresponds to a first backup instruction unit, and the other corresponds to a second backup instruction unit. The third instruction unit 60 and the fourth instruction unit 61 are included as backup instruction units. In this embodiment, the first drive circuit 42 serves as a first drive unit; the second drive circuit 43 serves as a second drive unit; the third drive circuit 62 serves as a third drive unit; and the fourth drive circuit 63 serves as a fourth drive unit.

In this embodiment, the first electromagnetic valve 34 serves as a first switching mechanism that switches between a state for blocking the communication between the wheel cylinder 15 in the first wheel 11 and the wheel cylinder 16 in the second wheel 12 and a state for allowing the communication. Furthermore, in this embodiment, the second electromagnetic valve 54 serves as a second switching mechanism that switches between a state for blocking the communication between the wheel cylinder 17 in the third wheel 13 and the wheel cylinder 18 in the fourth wheel 14, and a state for allowing the communication.

### OTHER EMBODIMENTS

The present embodiment may be modified in the following manner. The present embodiment and the following modification examples may be implemented in any combination, within a scope such combinations are not technically contradictory.

### (Handling of Three-System Failure)

By configuring the braking control device 10 in the manner to be described below, the braking force control can be continued even at the time of a three-system failure. Here, the three-system failure refers to a condition in which only one of the third instruction unit 60 and the fourth instruction unit 61, out of the first instruction unit 40, the second instruction unit 41, the third instruction unit 60, and the fourth instruction unit 61, is functioning properly.

To cope with a three-system failure, to begin with, it is necessary to make it possible to find out whether the third instruction unit 60 and the fourth instruction unit 61 are functioning properly or not, by enabling these instruction units to monitor each other, for example. When a three-system failure occurs, the braking control device 10 can continue the control of the braking force applied to the third wheel 13 and the fourth wheel 14, by operating in the manner described above.

FIG. 5 illustrates how the braking control device 10 operates when all of the ECUs other than the third instruction unit 60 fails. When the third instruction unit 60 determines that the instruction units other than the third instruction unit 60 are not operating properly, the third instruction unit 60 stops applying current to the second electromagnetic valve 54. As a result, the wheel cylinder 17 in the third wheel 13 and the wheel cylinder 18 in the fourth wheel 14 become connected to each other communicably, so that the third wheel actuator 51 can generate the third wheel hydraulic pressure P3 and the fourth wheel hydraulic pressure P4. The third instruction unit 60 then starts calculating the target third wheel hydraulic pressure P3*, and transmitting the calculated value to the third drive circuit 62. In this manner, the remaining third instruction unit 60 alone can control the braking force to be applied to the third wheel 13 and the fourth wheel 14.

When all of the instruction units other than the fourth instruction unit 61 fail, the current application to the second electromagnetic valve 54 stops. The fourth instruction unit 61 then calculates the target fourth wheel hydraulic pressure P4* and transmits the calculated value to the fourth drive circuit 63. In this manner, the remaining fourth instruction unit 61 alone can control the braking force applied to the third wheel 13 and the fourth wheel 14.

(Operation when One-System Failure Occurs)

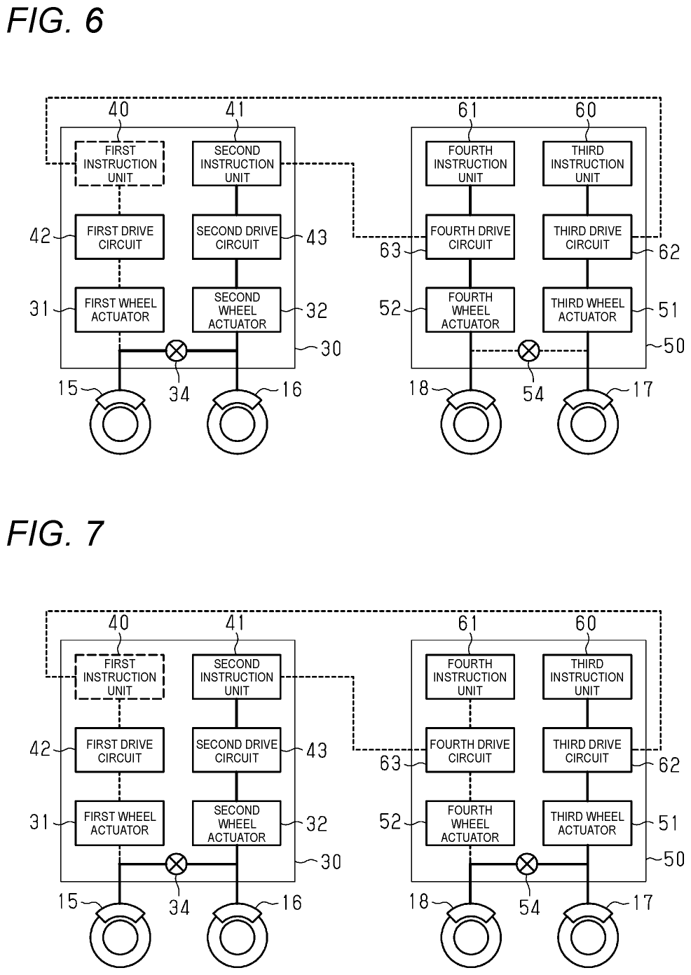

In the above embodiment, the functioning main instruction unit takes over the task of giving the instruction of braking force of the front wheel, and the backup instruction unit takes over the task of giving the instruction of braking force of the rear wheel, among the two wheels of the front wheel and the rear wheel, to which the failed main instruction unit has been giving the instruction of braking force during the normal condition. The functioning main instruction unit also continues giving the instruction of braking force to be applied to the two wheels of the front wheel and the rear wheel, in the same manner as in the normal condition, even at the time of the single-system failure. At the time of a single-system failure, however, the functioning main instruction unit may be configured to give instructions of the braking force to be applied to the two front wheels, and the backup instruction unit may be configured to give instructions of the braking force to be applied to the two rear wheels. FIG. 6 illustrates an example of how the braking control device 10 operates at the time of a single-system failure, in such a configuration. FIG. 7 illustrates another an example of how the braking control device 10 operates at the time of a single-system failure, in such a configuration.

In the example illustrated in FIG. 6, the second instruction unit 41 that is the functioning main instruction unit gives instructions of the braking force to be applied to the first wheel 11 and the second wheel 12, which are the front wheels. The third instruction unit 60 gives instructions of the braking force to be applied to the third wheel 13, and the fourth instruction unit 61 gives an instruction of braking force to be applied to the fourth wheel 14. Specifically, the second instruction unit 41 stops applying current to the first electromagnetic valve 34, and connects the wheel cylinder 15 in the first wheel 11 to the wheel cylinder 16 in the second wheel 12 communicably. The second instruction unit 41 calculates the target second wheel hydraulic pressure P2*, and transmits the calculated value to the second drive circuit 43, to give instructions of the braking force to be applied to the first wheel 11 and the second wheel 12. The third instruction unit 60 calculates the target third wheel hydraulic pressure P3*, and transmits the calculated value to the third drive circuit 62 to give the instruction of braking force to be applied to the third wheel 13. Furthermore, the fourth instruction unit 61 calculates the target fourth wheel hydraulic pressure P4*, and transmits the calculated value to the fourth drive circuit 63 to give the instruction of braking force to be applied to the fourth wheel 14.

Also in the example illustrated in FIG. 7, the second instruction unit 41, which is the functioning main instruction unit, gives the instructions of the braking force to be applied to the first wheel 11 and the second wheel 12. By contrast, in the example illustrated in FIG. 7, the third instruction unit 60 gives the instructions of the braking force to be applied to the third wheel 13 and the fourth wheel 14. Specifically, the third instruction unit 60 stops applying current to the second electromagnetic valve 54, and connects the wheel cylinder 17 in the third wheel 13 to the wheel cylinder 18 in the fourth wheel 14 communicably. The third instruction unit 60 then calculates the target third wheel hydraulic pressure P3*, and transmits the calculated value to the third drive circuit 62 to give the instructions of the braking force to be applied to the third wheel 13 and the fourth wheel 14. Alternatively, the fourth instruction unit 61 may be configured to give the instructions of the braking force to be applied to the third wheel 13 and the fourth wheel 14, in the manner described above.

In addition, the functioning main instruction unit may be configured to give the instructions of the braking force for the first wheel 11 and the second wheel 12 as follows. In other words, the functioning main instruction unit calculates the target first wheel hydraulic pressure P1* and the target second wheel hydraulic pressure P2*. The functioning main instruction unit may then transmit the calculated value of the target first wheel hydraulic pressure P1* to the first drive circuit 42, and transmit the target second wheel hydraulic pressure P2* to the second drive circuit 43, to instruct the braking force to be applied to the first wheel 11 and the second wheel 12, respectively. In this case, the functioning main instruction unit may calculate the target first wheel hydraulic pressure P1* and the target second wheel hydraulic pressure P2*, separately. In such a case, it is possible to generate different braking forces for the left front wheel and right front wheel, respectively, even at the time of a single-system failure. The functioning main instruction unit may also be configured to calculate only one target hydraulic pressure and transmit the same value to the first drive circuit 42 and the second drive circuit 43. In such a case, it is possible to suppress an increase in the processing load of the functioning main instruction unit at the time of a single-system failure.

In these cases, the backup instruction unit gives instructions of the braking force to be applied to the third wheel 13 and the fourth wheel 14, which are the left and right rear wheels, at the time of a single-system failure. By contrast, when the backup instruction unit is to take over the function of the failed main instruction unit as it is, the backup instruction unit needs to instruct the braking force to be applied to the front wheel and the rear wheel. Although the number of wheels for which the backup instruction unit gives instructions of the braking force is two, considering that these two wheels are both rear wheels, the processing load of the backup instruction unit is less than that when the two wheels are a combination of a front wheel and a rear wheel.

Therefore, the backup instruction unit is required to have lower processing power. In these configurations, the number of wheels for which the functioning main instruction unit gives instructions of the braking force at the time of a single-system failure is two, which is the same as that during the normal condition. Furthermore, the two wheels for which the functioning main instruction unit gives instruction of braking force during a single-system failure are both front wheels. Therefore, it is also possible to suppress an increase in the processing load of the functioning main instruction unit during the single-system failure.

### (Regarding Actuator Control)

In the embodiment, the drive circuit has been explained to control each of the actuators by adjusting the power for driving the actuator so as to match a detected value of the generated hydraulic pressure, being detected by the hydraulic pressure sensor, to the calculated value of the target hydraulic pressure, calculated by the instruction unit. Such control of the actuator may also be performed in the following manner. In other words, the instruction unit calculates the driving power based on the calculated value of the target hydraulic pressure and the detected value of the generated hydraulic pressure, and transmits the calculated driving power to the drive circuit. The drive circuit may then be configured to control the actuator by supplying the driving power received from the instruction unit to the actuator.

### Other Modifications

In the embodiment, the backup instruction unit has been explained to include two instruction units that are the third instruction unit 60 and the fourth instruction unit 61, but the backup instruction unit may include one instruction unit.

The first switching mechanism may use a plurality of electromagnetic valves to switch between a state for blocking the communication between the wheel cylinder 15 in the first wheel 11 and the wheel cylinder 16 in the second wheel 12 and a state for allowing the communication. It is also possible to provide a three-way valve serving both as the first switching mechanism and the master cut valve. The three-way valve in such a case is connected to three cylinders that are the master cylinder and the wheel cylinders 15, 16. The three-way valve is configured to be switchable among a state in which the three cylinders are hydraulically separated, a state in which any two of the three cylinders are connected, and a state in which the three cylinders are connected. The same kind of modification is also applicable to the second switching mechanism that switches between a state for blocking the communication between the wheel cylinder 17 of the third wheel 13 and the wheel cylinder 18 of the fourth wheel 14 and a state for allowing the communication.

The master cylinder may be omitted to provide a complete brake-by-wire braking control device.

As the first wheel actuator 31, the second wheel actuator 32, the third wheel actuator 51, and the fourth wheel actuator 52, electro-mechanical brakes (EMBs) that mechanically convert the power of the electric motor into braking force may be used. In such a case, each of the ECU gives an instruction of braking force applied to the corresponding wheel, for example, by calculating a target output value from the electric motor, and transmitting the target value to the drive circuit of the EMB.

In the embodiment described above, the first instruction unit 40 and the second instruction unit 41, which are the main instruction units, are mounted on the first braking unit 30. In addition, the third instruction unit 60 and the fourth instruction unit 61, which are the backup instruction units, are mounted on the second braking unit 50. These combinations of the ECUs mounted on the first braking unit 30 and the second braking unit 50 may be changed. For example, one main instruction unit and one backup instruction unit may be mounted on each of the first braking unit 30 and the second braking unit 50.

The first instruction unit 40, the second instruction unit 41, the third instruction unit 60, and the fourth instruction unit 61 may also be configured in the following manner. In other words, the present disclosure and noted features may be configured as one or more processors that operate according to a computer program, and one or more dedicated hardware circuits, e.g., dedicated hardware that executes at least part of various processes. The present disclosure and noted features may also be configured as a circuit including a combination of a processor and a dedicated hardware circuit. Examples of the dedicated hardware include an application-specific integrated circuit (ASIC). The processor includes a CPU and a memory such as a RAM and a ROM, and the memory stores therein a program code or a command configured to cause the CPU to execute processing. The memory that is a storage medium includes any available medium that can be accessed by a general-purpose or dedicated computer.

1. A braking control device that controls braking force to be applied to a first wheel, a second wheel, a third wheel, and a fourth wheel that are wheels of a vehicle, the braking control device comprising a first main instruction unit, a second main instruction unit, and a backup instruction unit as instruction units that instruct braking force to be applied to the wheels, wherein
when both of the first main instruction unit and the second main instruction unit are functioning properly, the first main instruction unit gives instructions of braking force to be applied to the first wheel and the third wheel, and the second main instruction unit gives instructions of braking force to be applied to the second wheel and the fourth wheel, and
when a failure causes only the second main instruction unit, out of the first main instruction unit and the second main instruction unit, to function properly, the second main instruction unit takes over a task of giving the instruction of braking force to be applied to the first wheel, and the backup instruction unit takes over a task of giving the instruction of braking force to be applied to the third wheel.

2. The braking control device according to claim 1, wherein the first wheel and the second wheel are a front left wheel and a front right wheel, respectively, the third wheel and the fourth wheel are a rear left wheel and a rear right wheel, respectively, and, when the failure occurs, the backup instruction unit takes over a task of giving an instruction of braking force to be applied to the fourth wheel.

3. The braking control device according to claim 1, further comprising:
a first wheel actuator that generates a hydraulic pressure in a wheel cylinder in the first wheel;
a second wheel actuator that generates a hydraulic pressure in a wheel cylinder in the second wheel; and
a first switching mechanism that switches between a state for blocking communication between the wheel cylinder in the first wheel and the wheel cylinder in the second wheel, and a state for allowing the communication, wherein
the first main instruction unit gives an instruction of braking force to be applied to the first wheel by giving an instruction of a hydraulic pressure to be generated, to the first wheel actuator,
the second main instruction unit gives an instruction of braking force to be applied to the second wheel by giving an instruction of a hydraulic pressure to be generated, to the second wheel actuator, and
when the failure occurs, the second main instruction unit switches the first switching mechanism from the state for blocking the communication to the state for allowing the communication, and gives instructions of braking force to be applied to the first wheel and the second wheel, by giving an instruction of a hydraulic pressure to be generated, to the second wheel actuator.

4. The braking control device according to claim 3, further comprising:
a third wheel actuator that generates a hydraulic pressure in a wheel cylinder in the third wheel;
a fourth wheel actuator that generates a hydraulic pressure in a wheel cylinder in the fourth wheel; and
a second switching mechanism that switches between a state for blocking communication between the wheel cylinder in the third wheel and the wheel cylinder in the fourth wheel, and a state for allowing the communication, wherein
the first main instruction unit gives an instruction of braking force to be applied to the third wheel by giving an instruction of a hydraulic pressure to be generated, to the third wheel actuator,
the second main instruction unit gives an instruction of braking force to be applied to the fourth wheel by giving an instruction of a hydraulic pressure to be generated, to the fourth wheel actuator, and
when the failure occurs, the backup instruction unit switches the second switching mechanism from the state for blocking the communication to the state for allowing the communication, and gives instructions of braking force to be applied to the third wheel and the fourth wheel, by giving an instruction of a hydraulic pressure to be generated, to the third wheel actuator.

5. The braking control device according to claim 4, wherein the backup instruction unit determines that the failure has occurred based on a fact that the first main instruction unit has ceased to instruct the hydraulic pressure to be generated, to the third wheel actuator.

6. The braking control device according to claim 4, wherein
the backup instruction unit includes a first backup instruction unit that gives an instruction of a hydraulic pressure to be generated, to the third wheel actuator, and a second backup instruction unit that gives an instruction of a hydraulic pressure to be generated, to the fourth wheel actuator,
when only the first backup instruction unit, among the first main instruction unit, the second main instruction unit, the first backup instruction unit, and the second backup instruction unit, is functioning properly, the first backup instruction unit switches a state of the second switching mechanism from the state for blocking the communication to the state for allowing the communication, and gives instructions of the braking force to be applied to the third wheel and the fourth wheel, by giving an instruction of a hydraulic pressure to be generated to the third wheel actuator, and
when only the second backup instruction unit, among the first main instruction unit, the second main instruction unit, the first backup instruction unit, and the second backup instruction unit, is functioning properly, the second backup instruction unit switches the state of the second switching mechanism from the state for blocking the communication to the state for allowing the communication, and gives an instruction of braking force to be applied to the third wheel and the fourth wheel, by giving an instruction of a hydraulic pressure to be generated to the fourth wheel actuator.

7. The braking control device according to claim 6, further comprising:
a first drive unit that drives an actuator for applying brake to the first wheel;
a second drive unit that drives an actuator for applying brake to the second wheel;
a third drive unit that drives an actuator for applying brake to the third wheel; and
a fourth drive unit that drives an actuator for applying brake to the fourth wheel, wherein
the first main instruction unit, the second main instruction unit, the first drive unit, and the second drive unit are mounted on a first braking unit, and
the backup instruction unit, the third drive unit, and the fourth drive unit are mounted on a second braking unit different from the first braking unit.

8. The braking control device according to claim 7, wherein, when the failure occurs, the second main instruction unit gives instructions for applying same braking force to the first wheel and to the second wheel.

9. The braking control device according to claim 9, wherein
the backup instruction unit includes a first backup instruction unit that gives an instruction of a hydraulic pressure to be generated, to the third wheel actuator, and a second backup instruction unit that gives an instruction of a hydraulic pressure to be generated, to the fourth wheel actuator,
when only the first backup instruction unit, among the first main instruction unit, the second main instruction unit, the first backup instruction unit, and the second backup instruction unit, is functioning properly, the first backup instruction unit switches a state of the second switching mechanism from the state for blocking the communication to the state for allowing the communication, and gives instructions of the braking force to be applied to the third wheel and the fourth wheel, by giving an instruction of a hydraulic pressure to be generated to the third wheel actuator, and
when only the second backup instruction unit, among the first main instruction unit, the second main instruction unit, the first backup instruction unit, and the second backup instruction unit, is functioning properly, the second backup instruction unit switches the state of the second switching mechanism from the state for blocking the communication to the state for allowing the communication, and gives an instruction of braking force to be applied to the third wheel and the fourth wheel, by giving an instruction of a hydraulic pressure to be generated to the fourth wheel actuator.

10. The braking control device according to claim 2, further comprising:
a third wheel actuator that generates a hydraulic pressure in a wheel cylinder in the third wheel;
a fourth wheel actuator that generates a hydraulic pressure in a wheel cylinder in the fourth wheel; and
a second switching mechanism that switches between a state for blocking communication between the wheel cylinder in the third wheel and the wheel cylinder in the fourth wheel, and a state for allowing the communication, wherein
the first main instruction unit gives an instruction of braking force to be applied to the third wheel by giving an instruction of a hydraulic pressure to be generated, to the third wheel actuator,
the second main instruction unit gives an instruction of braking force to be applied to the fourth wheel by giving an instruction of a hydraulic pressure to be generated, to the fourth wheel actuator, and
when the failure occurs, the backup instruction unit switches the second switching mechanism from the state for blocking the communication to the state for allowing the communication, and gives instructions of braking force to be applied to the third wheel and the fourth wheel, by giving an instruction of a hydraulic pressure to be generated, to the third wheel actuator.

11. The braking control device according to claim 10, wherein the backup instruction unit determines that the failure has occurred based on a fact that the first main instruction unit has ceased to instruct the hydraulic pressure to be generated, to the third wheel actuator.

12. The braking control device according to claim 2, further comprising:
a first drive unit that drives an actuator for applying brake to the first wheel;
a second drive unit that drives an actuator for applying brake to the second wheel;
a third drive unit that drives an actuator for applying brake to the third wheel; and
a fourth drive unit that drives an actuator for applying brake to the fourth wheel, wherein
the first main instruction unit, the second main instruction unit, the first drive unit, and the second drive unit are mounted on a first braking unit, and
the backup instruction unit, the third drive unit, and the fourth drive unit are mounted on a second braking unit different from the first braking unit.

13. The braking control device according to claim 2, wherein, when the failure occurs, the second main instruction unit gives instructions for applying same braking force to the first wheel and to the second wheel.

14. The braking control device according to claim 1, further comprising:
a third wheel actuator that generates a hydraulic pressure in a wheel cylinder in the third wheel;
a fourth wheel actuator that generates a hydraulic pressure in a wheel cylinder in the fourth wheel; and
a second switching mechanism that switches between a state for blocking communication between the wheel cylinder in the third wheel and the wheel cylinder in the fourth wheel, and a state for allowing the communication, wherein
the first main instruction unit gives an instruction of braking force to be applied to the third wheel by giving an instruction of a hydraulic pressure to be generated, to the third wheel actuator,
the second main instruction unit gives an instruction of braking force to be applied to the fourth wheel by giving an instruction of a hydraulic pressure to be generated, to the fourth wheel actuator, and
when the failure occurs, the backup instruction unit switches the second switching mechanism from the state for blocking the communication to the state for allowing the communication, and gives instructions of braking force to be applied to the third wheel and the fourth wheel, by giving an instruction of a hydraulic pressure to be generated, to the third wheel actuator.

15. The braking control device according to claim 14, wherein the backup instruction unit determines that the failure has occurred based on a fact that the first main instruction unit has ceased to instruct the hydraulic pressure to be generated, to the third wheel actuator.

16. The braking control device according to claim 15, wherein
the backup instruction unit includes a first backup instruction unit that gives an instruction of a hydraulic pressure to be generated, to the third wheel actuator, and a second backup instruction unit that gives an instruction of a hydraulic pressure to be generated, to the fourth wheel actuator,
when only the first backup instruction unit, among the first main instruction unit, the second main instruction unit, the first backup instruction unit, and the second backup instruction unit, is functioning properly, the first backup instruction unit switches a state of the second switching mechanism from the state for blocking the communication to the state for allowing the communication, and gives instructions of the braking force to be applied to the third wheel and the fourth wheel, by giving an instruction of a hydraulic pressure to be generated to the third wheel actuator, and
when only the second backup instruction unit, among the first main instruction unit, the second main instruction unit, the first backup instruction unit, and the second backup instruction unit, is functioning properly, the second backup instruction unit switches the state of the second switching mechanism from the state for blocking the communication to the state for allowing the communication, and gives an instruction of braking force to be applied to the third wheel and the fourth wheel, by giving an instruction of a hydraulic pressure to be generated to the fourth wheel actuator.

17. The braking control device according to claim 1, further comprising:
a first wheel actuator that generates a hydraulic pressure in a wheel cylinder in the first wheel;
a second wheel actuator that generates a hydraulic pressure in a wheel cylinder in the second wheel; and
a first switching mechanism that switches between a state for blocking communication between the wheel cylinder in the first wheel and the wheel cylinder in the second wheel, and a state for allowing the communication, wherein
the first main instruction unit gives an instruction of braking force to be applied to the first wheel by giving an instruction of a hydraulic pressure to be generated, to the first wheel actuator,
the second main instruction unit gives an instruction of braking force to be applied to the second wheel by giving an instruction of a hydraulic pressure to be generated, to the second wheel actuator, and
when the failure occurs, the second main instruction unit switches the first switching mechanism from the state for blocking the communication to the state for allowing the communication, and gives instructions of braking force to be applied to the first wheel and the second wheel, by giving an instruction of a hydraulic pressure to be generated, to the second wheel actuator.

18. The braking control device according to claim 1, wherein
the backup instruction unit includes a first backup instruction unit that gives an instruction of a hydraulic pressure to be generated, to the third wheel actuator, and a second backup instruction unit that gives an instruction of a hydraulic pressure to be generated, to the fourth wheel actuator,
when only the first backup instruction unit, among the first main instruction unit, the second main instruction unit, the first backup instruction unit, and the second backup instruction unit, is functioning properly, the first backup instruction unit switches a state of the second switching mechanism from the state for blocking the communication to the state for allowing the communication, and gives instructions of the braking force to be applied to the third wheel and the fourth wheel, by giving an instruction of a hydraulic pressure to be generated to the third wheel actuator, and
when only the second backup instruction unit, among the first main instruction unit, the second main instruction unit, the first backup instruction unit, and the second backup instruction unit, is functioning properly, the second backup instruction unit switches the state of the second switching mechanism from the state for blocking the communication to the state for allowing the communication, and gives an instruction of braking force to be applied to the third wheel and the fourth wheel, by giving an instruction of a hydraulic pressure to be generated to the fourth wheel actuator.

19. The braking control device according to claim 1, further comprising:
a first drive unit that drives an actuator for applying brake to the first wheel;
a second drive unit that drives an actuator for applying brake to the second wheel;
a third drive unit that drives an actuator for applying brake to the third wheel; and
a fourth drive unit that drives an actuator for applying brake to the fourth wheel, wherein
the first main instruction unit, the second main instruction unit, the first drive unit, and the second drive unit are mounted on a first braking unit, and
the backup instruction unit, the third drive unit, and the fourth drive unit are mounted on a second braking unit different from the first braking unit. 8. (New) The braking control device according to claim 1, wherein, when the failure occurs, the second main instruction unit gives instructions for applying same braking force to the first wheel and to the second wheel.

20. The braking control device according to claim 1, wherein, when the failure occurs, the second main instruction unit gives instructions for applying same braking force to the first wheel and to the second wheel.
